(19) United States
(12) Patent Application Publication
(10) Pub. No.: US 2023/0349206 A1
(43) Pub. Date: Nov. 2, 2023

(54) GATE LATCH

(71) Applicant: Elbee Pty Ltd., Bondi Junction (AU)

(72) Inventor: Andrew Marsden, Hingham, MA (US)

(73) Assignee: Elbee Pty Ltd., Bondi Junction (AU)

(21) Appl. No.: 18/139,210

(22) Filed: Apr. 25, 2023

Related U.S. Application Data
(60) Provisional application No. 63/336,516, filed on Apr. 29, 2022.

(51) Int. Cl. E05C 1/10; E05C 1/00; E06B 9/04

(52) U.S. Cl. CPC E05C 1/10; E05C 1/006; E06B 9/04; E06B 2009/002

(57) ABSTRACT

A gate includes a gate barrier and a hinge configured to allow the gate barrier to rotate about a rotation axis and translate along the rotation axis. The gate may include a gate latch coupled to the gate barrier, where the gate latch includes a latch bolt and a latch operator. The latch bolt may be configured to slide between an engaged position and a disengaged position in a first direction (e.g., a horizontal direction). The latch operator may be engaged with the latch bolt and configured to slide between a locking position and an unlocking position in a second, different direction (e.g., an inclined direction).

### RELATED APPLICATIONS

This application claims the benefit of priority under 35 U.S.C. § 119(e) to U.S. Provisional Application No. 63/336,516, filed on Apr. 29, 2022, which is herein incorporated by reference in its entirety.

### FIELD

Disclosed embodiments are related to safety gates and more specifically to gate latch assemblies and related methods of use.

### BACKGROUND

Safety gates are often employed to restrict or inhibit access to a certain area for a child or pet. Such safety gates may employ a latch and hinge arrangement that allow an adult to open the safety gate, while inhibiting a child from opening the gate. For example, a gate can be installed to help prevent a young child from accessing areas of a house, and a gate latch and gate hinge can be configured to allow an adult to perform one or more steps to open the gate barrier.

### SUMMARY

In some embodiments, a gate latch includes a latch body configured to be coupled to a gate barrier and a latch receptacle. The latch body includes a latch bolt configured to slide between an engaged position and a disengaged position in a first direction, the latch bolt including an inclined latch engagement face oriented toward a bottom of the latch bolt, and a latch operator engaged with the latch bolt and configured to slide between a locking position and an unlocking position in a second direction different from the first direction, where sliding the latch operator between the locking position and the unlocking position slides the latch bolt from the engaged position to the disengaged position. The latch receptacle is configured to receive and retain the latch bolt when the latch bolt is in the engaged position.

In some embodiments, a gate includes a frame, a gate barrier disposed in an opening of the frame, where the gate barrier is configured to rotate between an open position and a closed position and translate between a lower position and an upper position, an upper latch, and a lower latch. The upper latch includes a latch body coupled to the gate barrier, the latch body including a latch bolt configured to slide between an engaged position and a disengaged position in a first direction, the latch bolt including an inclined latch engagement face oriented toward a bottom of the latch bolt, and a latch operator engaged with the latch bolt and configured to slide between a locking position and an unlocking position in a second direction different from the first direction, where sliding the latch operator between the locking position and the unlocking position slides the latch bolt from the engaged position to the disengaged position. The upper latch may also include a latch receptacle coupled to the frame configured to receive and retain the latch bolt when the latch bolt is in the engaged position. The lower latch includes a pocket configured to receive a portion of the gate barrier when the gate barrier is in the closed position and the lower position.

In some embodiments, a method of operating a gate includes moving a latch operator in a first direction from a locking position to an unlocking position, moving a latch bolt with the latch operator in a second direction from an engaged position to a disengaged position as the latch operator moves from the locking position to the unlocking position, where the second direction is different than the first direction, and lifting a gate barrier with the latch bolt in the disengaged position from a lower position to an upper position, where lifting the gate barrier to the upper position allows the latch bolt to clear a latch receptacle.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an embodiment of a gate;

FIG. 2 is a perspective view of an upper latch of the gate of FIG. 1;

FIG. 3 is a side view of the upper latch of FIG. 2;

FIG. 4 is a cross-sectional view of the upper latch of FIG. 2 taken along line 4-4;

FIG. 5 is a perspective side view of one embodiment of a latch bolt and latch operator;

FIG. 6 is a perspective view of a lower latch of the gate of FIG. 1;

FIG. 7 is a flow chart a method of operating a gate according to exemplary embodiments; and

FIG. 8 is a perspective view of an upper hinge of the gate of FIG. 1.

### DETAILED DESCRIPTION

Safety gates are often employed in access points (e.g., doorways) to help prevent children or pets from accessing certain areas. Such safety gates include a gate barrier that can be moved by an adult. Safety gates typically employ mechanisms to ensure that an adult can operate the gate, while inhibiting a child or pet from opening the gate. Some gate barriers swing when moving between an open and a closed position. In such swing gates, one side of the barrier is rotatably attached at an upper hinge and lower hinge so that the gate swings open and closed, and the other side has a latching arrangement to secure the barrier in the closed position. On the securing side of a gate, a gate latch may secure a gate barrier in place by retaining a latch member that extends from the gate barrier. On the hinge side of the gate, the gate may be liftable (e.g., in a direction along a rotation axis of the hinge). In some conventional gates, the securing side of the gate is the sole side of the gate that secures the gate barrier in a closed position. Additionally, in many cases conventional gates are configured to accommodate automatic closure of a gate latch during rotational movement of the gate, which may compromise security of the gate in a closed position due to the features included which allow the gate to automatically close.

In view the above, the inventors have appreciated the benefits of a latching arrangement for a gate that allows automatic closure while ensuring a gate is secured in a closed position and is unable to rotate until the gate is lifted. In particular, the inventors have recognized the benefits of a latching arrangement in which the latches are configured to operate in a vertical direction and do not allow for rotational movement of the gate barrier. Additionally, the inventors have appreciated the benefits of a corresponding hinge arrangement configured to lock the hinge in the closed position, such that a gate barrier must be lifted before the hinge arrangement allows rotation. The inventors have appreciated that such an arrangement improves the security of the gate against externally applied torques compared with relying on a latch alone. Additionally, the inventors have appreciated the benefits of a gate latch including a latch operator and latch bolt that move in different directions, which may enable a variety of gate barrier shapes to be employed.

In some embodiments, a gate latch includes a latch body. The latch body may be configured to be coupled to a gate barrier. For example, the latch body may be configured to receive a crossbar of a gate barrier. The latch body may house and include a latch bolt and a latch operator. The latch bolt may be configured to slide at least partially within the latch body between an engaged position and a disengaged position. In the engaged position, the latch bolt may extend out of the latch body, and in the disengaged position the latch bolt may be disposed within the latch body. The latch bolt may slide in a first direction between the engaged position and the disengaged position (e.g., a horizontal direction). The latch operator may be configured to move the latch bolt from the engaged position to the disengaged position. The latch operator may abut the latch bolt and is configured to slide at least partially within the latch body between a locking position and an unlocking position. The latch operator may slide in a second direction different than the first direction (e.g., an inclined direction relative to a horizontal direction), which may allow the latch operator to be employed on curved or inclined surfaces. In some embodiments, the latch operator may only engage the latch bolt in one direction. In such embodiments, the latch bolt may move independently from the latch operator in some circumstances. For example, the latch bolt may move independently from the engaged position to a disengaged position without moving the latch operator. In cases where the latch bolt includes an inclined engagement face, such an arrangement may allow the latch bolt to move to the disengaged position more easily. Of course, in some embodiments the latch operator may be coupled to the latch bolt to always move correspondingly to the latch bolt, as the present disclosure is not so limited.

In some embodiments, a latch bolt of an upper gate latch may include an inclined latch engagement surface configured to move the latch bolt from an engaged position to a disengaged position when the latch engagement surface engages a surface of a latch receptacle. The latch engagement surface may allow a gate barrier to automatically close and latch, as the latch bolt may automatically move from the engaged position to the disengaged position, and subsequently move back into the engaged position inside of the latch receptacle. According to exemplary embodiments described herein, the latch bolt may be configured to latch the gate in a vertical direction parallel to an axis of rotation of a gate barrier. In such embodiments, the inclined latch engagement surface of the latch bolt may face downwards (e.g., is oriented toward a bottom of the latch bolt), such that the latch engagement surface is configured to engage an upward facing surface of the latch receptacle. Once disposed in the latch receptacle, the latch bolt may include a locking surface configured to resist upwards movement of the latch bolt relative to the latch receptacle until removed from the latch receptacle by moving the latch bolt to the disengaged position.

In some embodiments, a lower gate latch of a gate includes a pocket configured to receive a portion of a gate. In some embodiments, the lower gate latch may be configured to receive a lower crossbeam of a gate barrier. When the gate barrier is received in the pocket of the lower latch, the lower gate latch may be configured to inhibit rotation of the gate barrier. Accordingly, the gate barrier may be moved in a vertical direction to enter or exit the pocket. In some embodiments, the lower gate latch may be integrally formed and may not have any moving components, which may improve the security of the gate and may also be simpler to manufacture.

In some embodiments, a hinge of gate may be configured to allow a gate barrier to rotate between a closed position and an upper position. Additionally, in some embodiments herein, the hinge is configured to allow the gate barrier to translate along a rotation axis of the gate between a lower position and an upper position. In some embodiments, the hinge may be configured to inhibit rotation of the gate barrier while the gate barrier is not in the upper position. According to such embodiments, the gate barrier may be configured to move between the upper position and the lower position only in the closed position, such that whenever the gate barrier is in the open position the gate barrier is kept in the upper position. However, rotating the gate barrier to the closed position may allow the gate barrier to move to the lower position. Such an arrangement may ensure the latch of a gate operates in a vertical direction instead of a rotational direction when a latch is engaging a latch receptacle, which the inventors have appreciated may improve the security of a gate.

In some embodiments, a method of operating a gate includes moving a latch operator in a first direction from a locking position to an unlocking position. Moving the latch operator may include grasping the latch operator with a user's hand, or otherwise having the user engage the latch operator. The method may also include moving a latch bolt in a second direction from an engaged position to a disengaged position with the latch operator. The second direction may be different than the first direction, and in some cases the second direction may be a horizontal direction. The method may also include lifting a gate barrier from a lower position to an upper position with the latch bolt in the disengaged position. Once the gate is in the upper position, the latch bolt may be allowed to return to the engaged position (e.g., under biasing force from a spring). The method may further include rotating the gate from a closed position to an open position while the gate is in the upper position and rotating the gate from the open position back to the closed position. Once the gate barrier is back in the closed position, the method may include allowing the gate barrier to lower to the lower position. As the gate barrier moves to the lower position, an inclined latch engagement surface of the latch bolt may engage an upward facing surface of a latch receptacle to move the latch bolt from the engaged position to a disengaged position. The angle of the latch engagement face may be such that engagement with the upward facing surface of the latch receptacle generates a normal force component in the second direction to move the latch bolt to the disengaged position.

According to exemplary embodiments described herein, components of a gate latch or gate hinge may be integrally formed. For example, one or more components may be integrally molded (e.g., injection molded), 3D printed, or formed by another suitable process. In some embodiments, an upper portion of a latch body may be integrally molded, and a lower portion of the latch body may also be integrally molded. Likewise, in some embodiments, a latch operator and a latch bolt may be integrally molded. Various components of a gate hinge, such as upper and lower hinge portions may also be integrally molded in some embodiments. Such arrangements may simplify manufacturing of a gate latch or gate hinge according to exemplary embodiments described herein. Of course, any suitable construction and material may be employed for a gate latch or gate hinge, as the present disclosure is not so limited.

According to exemplary embodiments described herein, a gate latch or hinge may include one or more fasteners and/or one more springs. In some embodiments, the one or more fasteners may be employed to couple an upper portion of a latch body to a lower portion of the latch body. In some embodiments described herein, screw may be employed to couple an upper latch body portion to a lower latch body portion. Of course, in other embodiments, other suitable fasteners may be employed, including binding posts, pins, screws, bolts, tacks, and/or rivets. In some embodiments described herein, a spring may be employed to bias a gate latch component in a direction. For example, a spring may be employed to bias a latch bolt toward an engaged position. In some embodiments, the spring may be a compression spring. In other embodiments, any suitable spring may be employed, including a tension spring, torsion spring, air spring, or another type of spring, as the present disclosure is not so limited.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

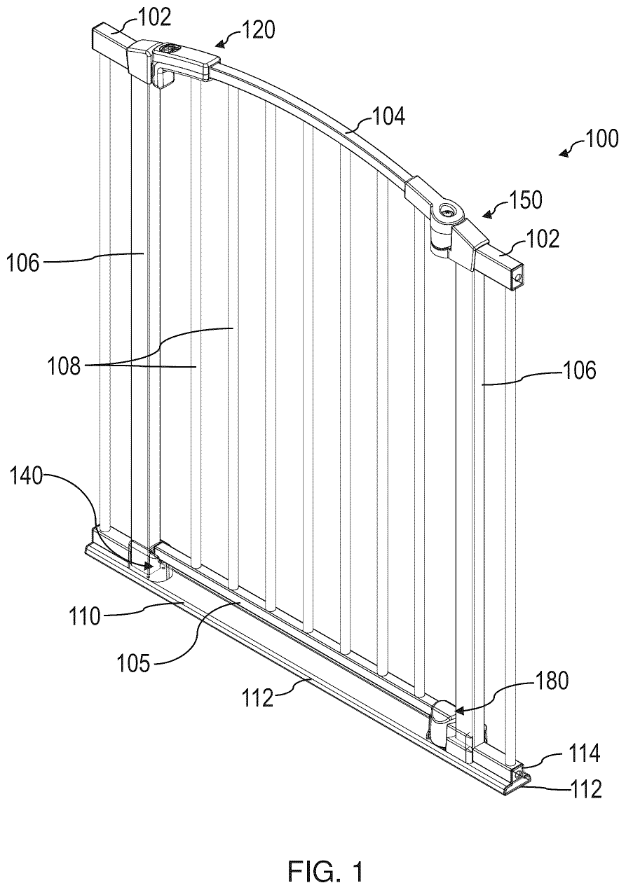

FIG. 1 is a perspective view of an embodiment of a gate 100. The gate includes a frame 102 that is configured to be placed in an access point such as a doorway. In some embodiments, the frame 102 may be a pressure gate frame configured to be compressed between two walls or jambs of a doorway. In such embodiments, the frame may include clamps configured to engage the walls and/or jambs of a doorway. In other embodiments, the frame may be configured to be fastened to the access point (e.g., using a suitable fastener such as a screw) without being compressed in the access point. As shown in FIG. 1, the gate includes a gate barrier 104 which is configured to swing (e.g., rotate) between open and closed positions. In the embodiment of FIG. 1, the gate barrier is configured to swing from a closed position shown in FIG. 1 to either of two open positions. The gate 100 also includes vertical stiles 106 framing the opening occupied by the gate barrier 104. The gate barrier includes barrier stiles 108 that are configured to inhibit access for a pet or a small child. The gate 100 also includes a lower crossbeam 110. In some embodiments as shown in FIG. 1, the lower crossbeam is configured to provide a low-profile opening that reduces protruding elements that may make crossing through the gate difficult. According to the depicted embodiment, the lower crossbeam 110 includes a bottom beam 112 and an upper beam 114. The bottom beam 112 extends along and entire transverse length of the gate (e.g., in a longitudinal direction of the bottom beam 112) and has a small thickness relative to its width. The upper beam 114 is disposed on either side of the gate and may be employed to assist in fastening the lower crossbeam to an access point (e.g., via clamping or fasteners as discussed above). As shown in FIG. 1, the upper beam 114 has a greater thickness than the bottom beam 112, but also has a lesser width than the bottom beam.

According to the embodiment of FIG. 1, the gate 100 includes a hinge side and a latch side. On the latch side, the gate includes an upper latch 120. The upper latch may be configured to be operable by a user to secure or open the gate barrier 104. The gate includes a lower latch 140 configured to receive a portion of the gate barrier 104 and inhibit the gate barrier from rotating in the closed position. On the hinge side, the gate includes an upper hinge 150 and a lower hinge 180. The upper hinge 150 and the lower hinge 180 are configured to selectively allow the gate barrier 104 to rotate from the closed position to an open position. Additionally, in the embodiment of FIG. 1, the upper hinge and lower hinge are configured to allow the gate barrier to be lifted vertically (e.g., translated along an axis of rotation of the gate barrier). Such a vertical lifting arrangement may selectively control the rotatability of the gate barrier, which makes the gate more secure and difficult to operate for a pet or small child. In some embodiments, the upper hinge may also function to bias the gate barrier 104 toward the closed position. According to exemplary embodiments described herein, the latch side of the gate may be configured to operate in a vertical direction only. That is, the upper latch 120 and the lower latch 140 may be configured to operate with the gate barrier 104 moving upwardly or downwardly in a vertical direction. The upper hinge 150 and lower hinge 180 may be configured such that any rotation of the gate barrier occurs above the upper latch 120 and the lower latch 140. Such an arrangement may improve security when the gate barrier is closed and latched, as pushing forces alone may not be suitable to open the gate, even if the upper latch is otherwise unlatched.

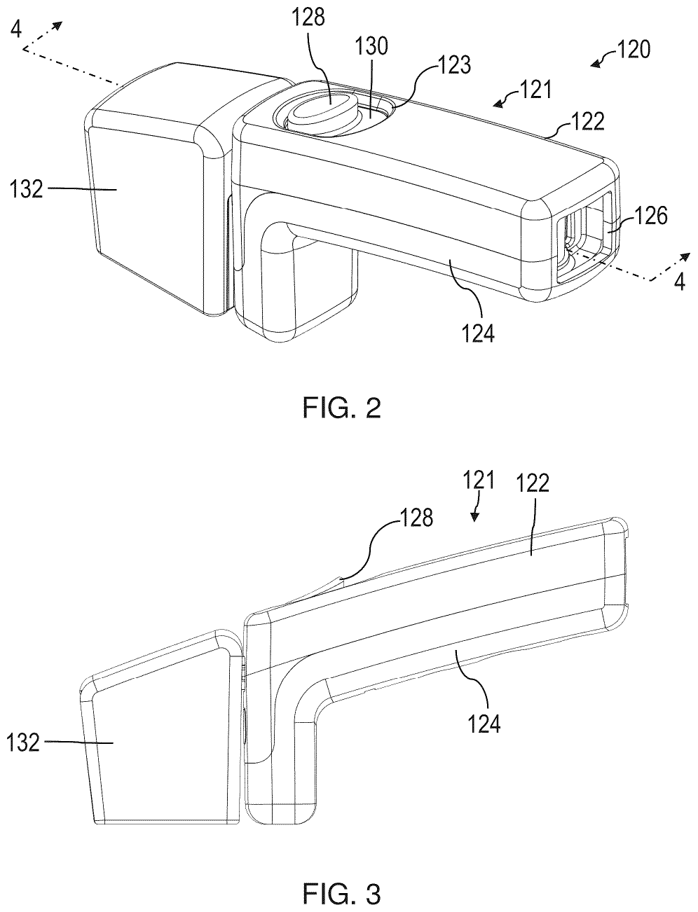

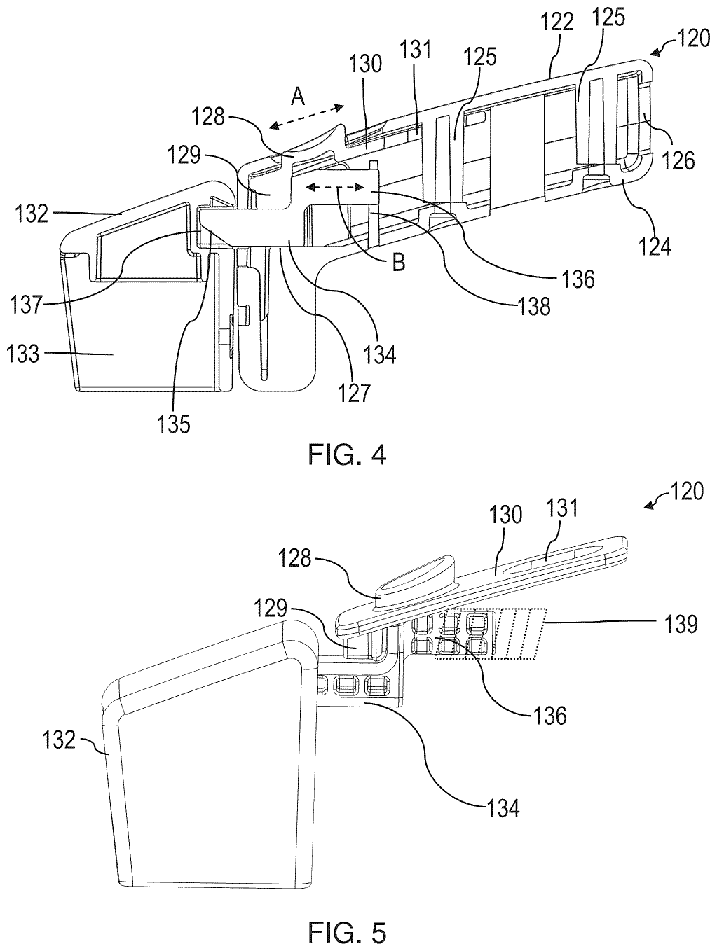

FIG. 2 is a perspective view and FIG. 3 is a side view of an upper latch 120 of the gate of FIG. 1. As shown in FIGS. 2-3, the upper latch includes a latch body 121 and a latch receptacle 132. The latch body 121 is configured to be coupled to a gate barrier and includes an upper portion 122 and a lower portion 124. The latch body also includes an opening 126 through which a crossbeam of the gate barrier may be received and retained. As shown in FIGS. 2-3, the latch body is formed in an L-shape, which may provide additional support for a latch bolt, as will be discussed further with reference to FIG. 4.

According to the embodiment of FIGS. 2-3, the latch body is configured to support the latch bolt and a latch operator 128. The latch bolt is configured to move between an engaged position where the latch bolt engages a pocket of the latch receptacle 132 and a disengaged position where the latch bolt clears the pocket of the latch receptacle. The latch operator 128 is configured to control the position of the latch bolt and is manipulated by a user. In the embodiment of FIGS. 2-3, the latch operator extends partially out of the latch body 121 through a slot 123 formed in the upper portion 122 of the latch body. As shown in FIG. 2, the latch operator includes a plate 130 configured to slide within the latch body 121. The latch operator is configured to slide in the latch body between a locking position (shown in FIG. 2) and an unlocking position. In some embodiments as shown in FIG. 2, the locking position and the unlocking position may be defined by the ends of the slot 123. As shown in FIG. 3, the latch operator 128 may slide in a direction parallel to a direction of an upper surface of the latch body 121, such that the movement of the latch operator conforms to the geometry of a received gate barrier.

FIG. 4 is a cross-sectional view of the upper latch 120 of FIG. 2 taken along line 4-4. As shown in FIG. 4, the upper portion 122 and the lower portion 124 are attached to one another to form the latch body. In some embodiments has shown in FIG. 4, the upper portion and the lower portion are attached to one another with posts 125. The posts may be configured to receive a fastener (e.g., a screw, rivet, etc.) to attach the upper portion to the lower portion. In some embodiments, an integrated snap-fit or other interference fit may be employed to secure the upper portion to the lower portion. In some embodiments, the posts 125 may be received through holes formed in a crossbeam of a gate barrier to secure the crossbeam to the latch body. Of course, any suitable attachment between a latch body and a crossbeam may be employed, as the present disclosure is not so limited.

As shown in FIG. 4, the upper latch 120 includes a latch operator 128 and a latch bolt 134. The latch operator includes a plate 130 and a bolt engagement portion 129. The latch operator is configured to slide within the upper portion 122 of the latch body between a locking position and an unlocking position. In particular, the latch operator is configured to slide in a first direction A. As shown in FIG. 4, the plate 130 is configured to support the sliding motion of the latch operator. In some embodiments as shown in FIG. 4, the plate may include a slot 131 which surrounds a post 125. The slot 131 may determine a range of motion of the latch operator 128, and in some cases may determine a locking position and unlocking position, where a first end of the slot 131 corresponds to the locking position and a second end of the slot 131 corresponds to the unlocking position. The latch bolt 134 includes an inclined latch engagement surface 135 and a tail 136. In the embodiment of FIG. 4, the bolt engagement portion 129 is configured to slidingly engage the tail 136 of the latch bolt 134 to move the latch bolt between an engaged position (shown in FIG. 4) and a disengaged position where the latch bolt is moved into the latch body. The latch bolt 134 is configured to slide in a second direction B between the engaged position and the disengaged position, which in the depicted embodiment is a horizontal position. The second direction B is different than the first direction A, and in the embodiment of FIG. 4 the first direction is inclined relative to the second direction B. Accordingly, when the latch operator is moved in direction A, the bolt engagement portion 129 may slide along the tail 136. The lower portion 124 of the latch body includes a support 138 configured to support the sliding movement of the latch bolt 134. Additionally, the lower portion includes a base 127 configured to provide a sliding surface along which a bottom surface of the latch bolt slides and provides additional structural support to the latch bolt to resist upward travel when engaged with the latch receptacle 132.

According to the embodiment of FIG. 4, the latch operator 128 and latch bolt 134 are independent from one another. The latch operator 128 abuts a side of the latch bolt 134 to move the latch bolt from an engaged position to a disengaged position when the latch operator moves from the locking position to the unlocking position. However, the latch bolt 134 is free to move from the engaged position to the disengaged position without moving the latch operator 128. Of course, in other embodiments the latch operator may be coupled to move correspondingly to the latch bolt, as the present disclosure is not so limited.

As shown in FIG. 4, the latch bolt 134 is configured to engage the latch receptacle 132 to inhibit movement of the latch body in an upward direction (e.g., parallel to a rotation axis of an associated gate barrier). The latch bolt 134 may also be configured to inhibit rotation of the associated gate barrier. The latch receptacle includes a frame coupler 133 configured to couple the latch receptacle to a frame of a gate. In the state shown in FIG. 4, the latch bolt is in an engaged position and is disposed within a pocket 137 of the latch receptacle 132. The pocket is configured to retain the latch bolt until the latch bolt is moved to the disengaged position and clears the pocket. According to the embodiment of FIG. 4, the latch bolt includes an inclined latch engagement surface 135 which is facing a downward direction toward a bottom of the latch bolt. When the latch bolt is disposed above the latch receptacle, the latch body may be lowered to bring the latch engagement surface 135 into contact with the latch receptacle. Due to the inclination of the latch engagement surface, the latch bolt may be moved from the engaged position to the disengaged position. Once the latch bolt is aligned with the pocket 137, the latch bolt may be free to extend into the engaged position (e.g., under biasing force from a spring). In this manner, the upper latch 120 may allow automatic closure and latching of a gate barrier.

FIG. 5 is a perspective side view of one embodiment of a latch bolt 134 and latch operator 128. As shown in FIG. 5, the latch operator includes a bolt engagement portion 129 configured to engage a tail 136 of the latch bolt 134 to move the latch bolt from an engaged option to a disengaged position. The latch bolt is configured to move in a first direction and the latch operator is configured to move in a second direction different than the first direction. Accordingly, the bolt engagement portion may be configured to slide along the tail 136 in a direction perpendicular to the first direction as the latch operator slides in the second direction. In the embodiment of FIG. 5, the tail 136 supports a spring 139, which is a compression spring. The compression spring may be configured to apply a force biasing the latch bolt 134 toward the engaged position. Due to the engagement with the bolt engagement portion 129, the spring may also bias the latch operator 128 to a locking position.

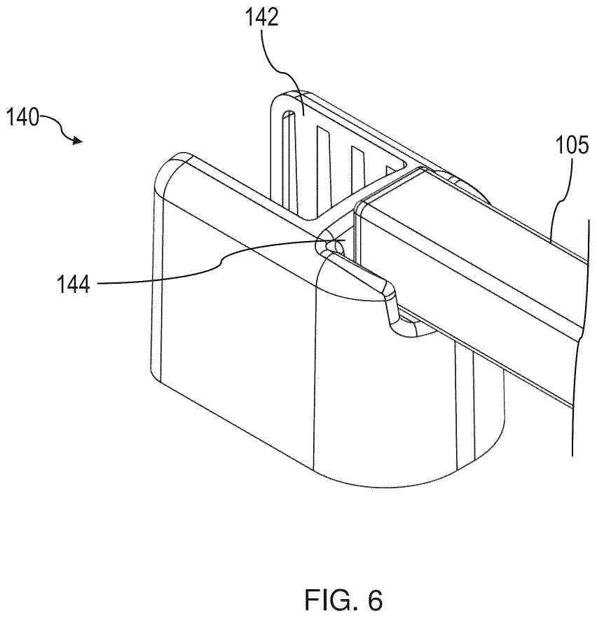

FIG. 6 is a perspective view of a lower latch 140 of the gate of FIG. 1. As shown in FIG. 6, the lower latch includes a frame coupler 142 configured to couple the lower latch to a frame of a gate. The lower latch also includes a pocket 144. The pocket is configured to receive a lower crossbeam 105 of a gate barrier. According to the embodiment of FIG. 6, the lower latch is unitary and does not include any moving components. The pocket is configured to receive the crossbeam 105 in a vertical direction. While the crossbeam is disposed in the pocket, the bottom latch is configured to inhibit rotation of the gate barrier. Accordingly, to rotate the gate barrier the gate barrier is first lifted to remove the crossbeam 105 from the pocket 144.

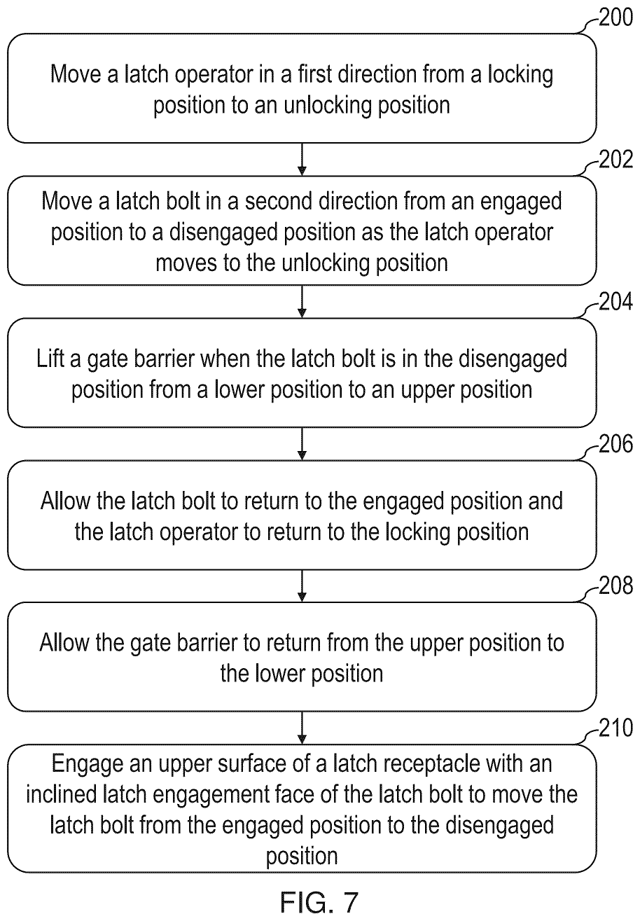

FIG. 7 is a flow chart for an embodiment of a method of operating a gate according to exemplary embodiments described herein. In block 200, the method includes first moving a latch operator in a first direction from a locking position to an unlocking position. In some embodiments, moving the latch operator in the first direction may include grasping the latch operator and applying force to the latch operator in the first direction. In block 202, a latch bolt is moved in a second direction from an engaged position to a disengaged position as the latch operator moves to the unlocking position. In some embodiments, moving the latch bolt may include abutting the latch bolt with the latch operator. In block 204, a gate barrier is lifted from a lower position to an upper position when the latch bolt is in the disengaged position. In some embodiments, lifting the gate barrier may allow the latch bolt to clear a latch receptacle. In some embodiments, while the gate barrier is in the upper position, the gate barrier may be rotated between a closed position and an open position. In block 206, the latch bolt is allowed to return to the engaged position and the latch operator is allowed to return to the locking position. In some embodiments, allowing the latch bolt to return to the engaged position includes biasing the latch bolt to the engaged position with a spring and releasing the latch operator. In block 208, the gate barrier may be allowed to return from the upper position to the lower position. For example, the gate barrier may be held by a user and released and allowed to drop under the effect of gravity. In block 210, an upper surface of a latch receptacle is engaged with an inclined latch engagement face of the latch bolt to move the latch bolt from the engaged position to the disengaged position. The inclined latch engagement face may be configured to engage the upper surface as the gate barrier moves from the upper position to the lower position.

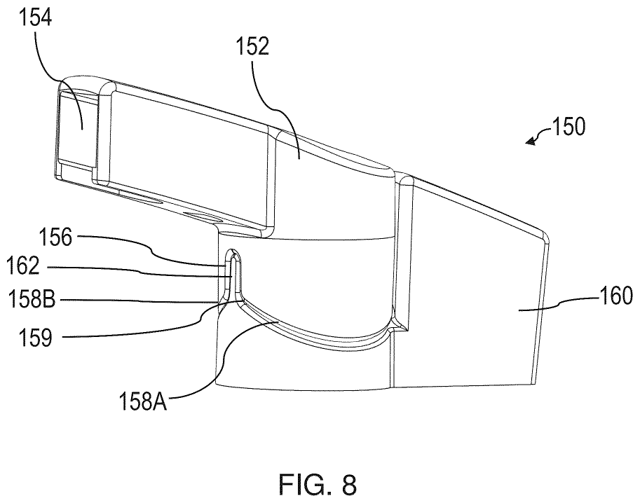

FIG. 8 is a perspective view of an upper hinge 150 of the gate of FIG. 1. As shown in FIG. 8, the upper hinge 150 includes an upper hinge portion 152 (e.g., a first portion of the upper hinge) and a lower hinge portion 160 (e.g., a second portion of the upper hinge). The upper hinge portion includes a gate barrier coupler 154 configured to couple the upper hinge portion to a gate barrier. The lower hinge portion 160 is configured to support the upper hinge portion 152 and allow the upper hinge portion to rotate. In the embodiment of FIG. 8, the lower hinge portion is also configured to allow the upper hinge portion to be translated along an axis of rotation of the upper hinge portion (e.g., lifted vertically).

According to the embodiment of FIG. 8, the upper hinge 150 is configured to secure a gate barrier in a closed position to enhance the security of the gate. That is, the upper hinge 150 is configured to resist rotation of the gate barrier when the gate barrier is in the closed position. Accordingly, the gate barrier is not reliant on only the latch side of the gate to remain closed. As shown in FIG. 8, the upper hinge portion 152 includes a receptacle 156. The receptacle extends in a direction parallel to a rotation axis of the upper hinge portion and is configured to receive a projection 162 of the lower hinge portion 160, such that the projection and the receptacle engage in a direction parallel to the rotation axis. When the projection 162 is engaged with the receptacle 156, the upper hinge portion may be inhibited from rotating relative to the lower hinge portion due to the interference between the projection and the receptacle. In some embodiments as shown in FIG. 8, the receptacle 156 and the projection 162 are externally disposed on the upper hinge portion 152 and the lower hinge portion 160. Such an arrangement may increase the radial distance between a rotation axis of the upper hinge portion and the receptacle 156 and projection 162, giving the receptacle and projection more leverage to resist externally applied torques on a gate barrier. To allow the upper hinge portion 152 to rotate relative to the lower hinge portion 160, the upper hinge portion 152 may be translated along its rotation axis away from the lower hinge portion to disengage the projection 162 from the receptacle 156. Once the receptacle 156 and projection 162 are disengaged, the upper hinge portion may be rotatable such that the upper hinge portion and associated gate barrier may be swung to an open position.

In the embodiment of FIG. 8, the upper hinge portion 152 is configured to bias a gate barrier to a closed position. That is, the upper hinge portion 152 is configured to bias itself toward a position in which the receptacle 156 is aligned with the projection 162, such that the projection 162 may engaged the receptacle under the effect of gravity and/or a biasing force to secure the gate barrier in a closed position. As shown in FIG. 8, the upper hinge portion includes a first ramp 158A and a second ramp 158B. The first ramp is disposed adjacent the receptacle 156 and extends downwardly from the receptacle in a first circumferential direction. The second ramp is likewise disposed adjacent the receptacle 156 and extended downward from the receptacle in a second circumferential direction opposite the first circumferential direction. The first ramp and the second ramp are each configured to engage the projection 162 of the lower hinge portion 160 as the upper hinge portion rotates about its rotation axis in either a first direction or a second direction. As the upper hinge portion rotates, the engagement between the projection 162 and either the first ramp 158A or the second ramp 158B causes the upper hinge portion to be moved further away from the lower hinge portion (e.g., lifted) as the upper hinge portion rotates. When the projection is in contact with either the first ramp or the second ramp and the upper hinge portion is released, the inclination of the ramp causes the upper hinge portion to rotate back toward a closed position. That is, the first ramp and second ramp are configured to urge the upper hinge portion back to a closed position when the upper hinge portion is forced against the projection 162. The force employed to urge the upper hinge portion back to the closed position may be generated in part by gravity acting on the gate barrier and upper hinge portion. The force may also include a biasing force from a spring, in some embodiments. As shown in FIG. 8, the first ramp 158A and second ramp 158B transition to the receptacle 156 at lead-ins 159, which may facilitate entry of the projection 162 into the receptacle once the upper hinge portion is in the closed position.

According to some embodiments, an upper hinge 150 may include multiple projections and multiple corresponding receptacles. In some embodiments, an upper gate hinge may include a pair of receptacles and projections disposed on opposing sides of a rotation axis of the hinge (e.g., 180 degrees apart from one another). Such an arrangement may facilitate opening and closing of a gate as the two projections may provide multiple supporting surfaces for an upper hinge portion. Additionally, such an arrangement may improve the security of the gate in a closed position, as torque applied to the gate may be resisted on both sides of an axis of rotation. Of course, any suitable number of projections and receptacles may be employed, including a single projection and receptacle, as the present disclosure is not so limited.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A gate latch comprising:
a latch body configured to be coupled to a gate barrier, the latch body comprising:
a latch bolt configured to slide between an engaged position and a disengaged position in a first direction, the latch bolt including an inclined latch engagement face oriented toward a bottom of the latch bolt, and
a latch operator engaged with the latch bolt and configured to slide between a locking position and an unlocking position in a second direction different from the first direction, wherein sliding the latch operator between the locking position and the unlocking position slides the latch bolt from the engaged position to the disengaged position; and
a latch receptacle configured to receive and retain the latch bolt when the latch bolt is in the engaged position.

2. The gate latch of claim 1, wherein the first direction is a horizontal direction, and wherein the second direction is inclined relative to the horizontal direction.

3. The gate latch of claim 1, wherein the inclined latch engagement face is configured to move the latch bolt from the engaged position to the disengaged position when the latch engagement face engages an upward facing surface of the latch receptacle.

4. The gate latch of claim 3, wherein the inclined latch engagement face is configured to move the latch bolt from the engaged position to the disengaged position while the latch operator remains in the locking position.

5. The gate latch of claim 1, wherein the latch body further comprises a spring coupled to the latch bolt configured to bias the latch bolt to the engaged position.

6. The gate latch of claim 1, wherein the latch body comprises an upper portion, a lower portion and a post extending between the upper portion and the lower portion, wherein the latch operator comprises an operator slot surrounding the post, wherein a first end of the operator slot defines the locking position and wherein a second end of the operator slot defines the unlocking position.

7. The gate latch of claim 6, wherein the lower portion slidingly supports a bottom surface of the latch bolt.

8. A gate comprising:
a frame;
a gate barrier disposed in an opening of the frame, wherein the gate barrier is configured to rotate between an open position and a closed position and translate between a lower position and an upper position;
an upper latch comprising:
a latch body coupled to the gate barrier, the latch body comprising:
a latch bolt configured to slide between an engaged position and a disengaged position in a first direction, the latch bolt including an inclined latch engagement face oriented toward a bottom of the latch bolt, and
a latch operator engaged with the latch bolt and configured to slide between a locking position and an unlocking position in a second direction different from the first direction, wherein sliding the latch operator between the locking position and the unlocking position slides the latch bolt from the engaged position to the disengaged position, and a latch receptacle coupled to the frame configured to receive and retain
the latch bolt when the latch bolt is in the engaged position; and
a lower latch comprising a pocket configured to receive a portion of the gate barrier when the gate barrier is in the closed position and the lower position.

9. The gate of claim 8, wherein the first direction is a horizontal direction, and wherein the second direction is inclined relative to the horizontal direction.

10. The gate of claim 8, wherein the inclined latch engagement face is configured to move the latch bolt from the engaged position to the disengaged position when the latch engagement face engages an upward facing surface of the latch receptacle as the gate barrier moves from the upper position to the lower position.

11. The gate of claim 10, wherein the inclined latch engagement face is configured to move the latch bolt from the engaged position to the disengaged position while the latch operator remains in the locking position.

12. The gate of claim 8, wherein the latch body further comprises a spring coupled to the latch bolt configured to bias the latch bolt to the engaged position.

13. The gate of claim 8, wherein the latch body comprises an upper portion, a lower portion and a post extending between the upper portion and the lower portion, wherein the latch operator comprises an operator slot surrounding the post, wherein a first end of the operator slot defines the locking position and wherein a second end of the operator slot defines the unlocking position.

14. The gate of claim 13, wherein the lower portion slidingly supports a bottom surface of the latch bolt.

15. The gate of claim 8, further comprising a gate hinge coupled to the gate barrier configured to inhibit the gate barrier from rotating between the open position and the closed position when the gate barrier is in the lower position.

16. The gate of claim 8, wherein the pocket is configured to receive the portion of the gate barrier when the gate barrier moves from the upper position to the lower position.

17. A method of operating a gate, the method comprising:
moving a latch operator in a first direction from a locking position to an unlocking position;
moving a latch bolt with the latch operator in a second direction from an engaged position to a disengaged position as the latch operator moves from the locking position to the unlocking position, wherein the second direction is different than the first direction; and
lifting a gate barrier with the latch bolt in the disengaged position from a lower position to an upper position, wherein lifting the gate barrier to the upper position allows the latch bolt to clear a latch receptacle.

18. The method of claim 17, wherein the second direction is a horizontal direction, and wherein the first direction is inclined relative to the horizontal direction.

19. The method of claim 17, further comprising:
biasing the latch bolt to the engaged position; and
allowing the latch bolt to return to the engaged position after being moved to the disengaged position.

20. The method of claim 19, further comprising:
moving the gate barrier from the upper position to the lower position; and
engaging an upper surface of the latch receptacle with an inclined latch engagement face of the latch bolt to move the latch bolt from the engaged position to the disengaged position as the gate barrier moves from the upper position to the lower position.
